(19) United States
(12) Patent Application Publication
(10) Pub. No.: US 2025/0362504 A1
(43) Pub. Date: Nov. 27, 2025

(54) OPTICAL WAVEGUIDE HAVING A CURVED GRIN ELEMENT

(71) Applicant: Carl Zeiss AG, Oberkochen (DE)

(72) Inventors: Christoph MENKE, Oberkochen (DE); Norbert KERWIEN, Moegglingen (DE); Andrea BERNER, Jena (DE)

(21) Appl. No.: 18/874,800

(22) PCT Filed: Jun. 12, 2023
(86) PCT No.: PCT/EP2023/065628

§ 371 Date: Dec. 13, 2024

(30) Foreign Application Priority Data
Jun. 14, 2022 (DE) 102022114914.5

(51) Int. Cl. G02B 27/01; G02B 27/00

(52) U.S. Cl. CPC G02B 27/0172; G02B 27/0025; G02B 2027/011; G02B 2027/013

(57) ABSTRACT

An optical waveguide is provided for arrangement in the beam path of an optical arrangement with a device for output coupling and/or input coupling an imaging beam path. The optical waveguide includes a GRIN element having at least one curved surface. The GRIN element has a refractive index distribution designed to reduce the aberrations, arising due to the curvature of the GRIN element, in an imaging path of a virtual image created by light waves guided in the optical waveguide by total-internal reflection.

### PRIORITY

This application claims the benefit of German Patent Application No. 10 2022 114 914.5 filed on Jun. 14, 2022, which is hereby incorporated herein by reference in its entirety.

### FIELD

The present invention relates to an optical waveguide for arrangement in the beam path of an optical arrangement, e.g. of a head-mounted display (HMD), of a head-up display (HUD), of a near-to-eye display or an imaging arrangement or imaging apparatus (smartglasses, for example with gesture recognition or eye tracking). Moreover, the invention relates to an optical arrangement, e.g. for one of the aforementioned applications, an image capture apparatus and an image reproduction apparatus.

### BACKGROUND

Head-mounted displays, for example in the form of smartglasses or AR (augmented reality) headsets or VR (virtual-reality) headsets or MR (mixed reality) headsets or VR or MR glasses or VR or MR helmets, are used in numerous contexts. In this context, after light waves for creating a virtual image have been input coupled into an optical waveguide, they are usually guided by means of total-internal reflection until they are output coupled. When a user looks through “augmented reality glasses”, or “AR glasses” for short, they see an input coupled or superimposed “virtual image” overlaid on their image of the physical world (“real image”). This overlay is achieved by way of a beam combiner which, on the one hand, is transparent to ambient light but, on the other hand, also steers a beam created by an external picture generator to the eye or into an eye box. The eye perceives this beam as a virtual image. In the context of the present invention, a respective imaging path is defined for the purpose of describing the beam path for the image of the physical surroundings and the beam path for the input coupled virtual image. In the present case, an imaging path is understood to mean the path of light from the object, e.g. an object in the physical surroundings, or from the picture generator/projector, which emits the virtual image to be input coupled, to the location of image creation or perception of the image representation, e.g. the eye of a user or the eye box.

The most common optical waveguide technologies in AR headsets are based on planar or plane parallel optical waveguides. However, curved optical waveguides would be desirable, in order to support an appealing product design. Refractive error correction is typically realized by way of a so-called push-pull lens concept, i.e. a combination of lenses with different refractive powers upstream and downstream of the optical waveguide. However, together with a planar optical waveguide, this results in large overall system thicknesses, and hence a high overall weight of the optical unit.

An optical waveguide (light guide) is understood to mean a waveguide designed to guide or transmit light waves through the waveguide in the interior thereof by way of total-internal reflection at the waveguide surfaces. Light waves are understood to mean electromagnetic waves at wavelengths in the range between 300 nm (ultraviolet light) and 2 μm (infrared light), in particular light waves in the visible range and near infrared range and near ultraviolet range.

DE 10 2016 105 060 B3 describes e.g. a curved lens for an imaging optical unit and a pair of smartglasses.

In the case of a head-mounted display, e.g. in the case of AR headsets, the image created by a picture-generating unit or a display is input coupled into the optical waveguide, reflected one or more times within the optical waveguide by means of total-internal reflection and finally output coupled such that a user of the head-mounted display can see a virtual image. The region in space from where the virtual image is visually perceivable by a user is also referred to as an eye box. The two outer faces of the optical waveguide are frequently embodied as parallel plane faces so that neither optical refractive power nor aberrations, which impair the image quality, are created within the optical waveguide. Moreover, head-mounted displays, e.g. AR headsets, may comprise an optical waveguide and one or more additional lenses (push-pull lens principle) per eye. This one lens or this plurality of additional lenses serves to correct the ametropia (refractive error) or presbyopia of the eye (pull lens) and/or to let the virtual image appear in focus at a desired distance (pull lens) without impairing the image of the physical surroundings (push lens).

Lenses for glasses usually have a meniscus-type shape. If an optical waveguide is integrated as a plane parallel plate into a lens for a pair of glasses that is intended to be used as a head-mounted display, then the combination of the optical waveguide with the push-pull lenses necessarily leads to thick, voluminous and heavy systems. It is obvious that the overall thickness of a lens for a pair of glasses that consists of push-lens, plane optical waveguide and pull-lens increases with the curvature of the meniscus. However, relatively strong curvatures are required to correct significant refractive errors (ametropia, e.g. more than +/−3 diopters) or presbyopia in progressive addition lenses.

As a rule, and especially in the case of large fields of view (FOVs), the use of a curved optical waveguide leads to significant astigmatic imaging errors in the virtual image which cannot be compensated for within the optical waveguide. A correction outside of the optical waveguide is not possible either since the view through the glasses (imaging path of the real image representation of the surroundings) of the objects in the environment must not be impaired.

### SUMMARY

An object herein is to provide an advantageous optical waveguide for arrangement in the beam path of an optical arrangement, an optical arrangement, an image capture apparatus and an image reproduction apparatus.

The optical waveguide for arrangement in the beam path of an optical arrangement, e.g. an image reproduction apparatus and/or an image capture apparatus, can comprise a device for output coupling and/or input coupling an imaging beam path, i.e. light waves.

For example, the waveguide can be a waveguide of a head-mounted display. In particular, the waveguide can be designed to create a virtual image representation and at the same time afford a view of the surroundings, i.e. create a real image representation of the surroundings. Moreover, it can be designed for arrangement between a picture-generating unit and an eye box of a head-mounted display.

The optical waveguide can comprise a GRIN element. A GRIN element or a GRIN material is understood to mean a gradient index element or gradient index material (GRIN), which has a refractive index profile or a refractive index distribution with a gradient. The GRIN element is designed to guide light waves by means of total-internal reflection and is not a constituent part of a device for input coupling and/or output coupling an imaging beam path, i.e. light waves. In other words, it can be arranged as an integral constituent part of the optical waveguide in the beam path between an input coupling device and an output coupling device.

The GRIN element of the optical waveguide can comprise at least one curved surface. The surface can be concavely or convexly curved. For example, the GRIN element might comprise a concavely or convexly curved first surface, for example a back side with a radius of curvature R₁=r′, and a concavely or convexly curved second surface, for example a front side with a radius of curvature R₂=r. The surfaces can also be configured as free-form surfaces or aspherical surfaces. An aspherical surface is understood to mean a rotationally symmetric optical surface, the radius of curvature of which varies radially with distance from the center.

The GRIN element moreover has a refractive index distribution designed to reduce the aberrations, brought about by the curvature of the GRIN element, in an imaging path of a virtual image representation created by means of light waves guided in the optical waveguide by total-internal reflection. Thus, the refractive index distribution is designed to at least partially correct, preferably completely correct, the aforementioned aberrations.

The virtual image aberrations to be corrected arise due to the curvature of the waveguide since reflection (total-internal reflection at surfaces of the optical waveguide) at a curved face has an optical power. The curved face changes the beam convergence. The convergence thus changes with each reflection in the case of multiple reflections, whereby aberrations occur, especially a strong astigmatism. The refractive index profile of the GRIN material now allows correction of these typical aberrations of a simple curved optical waveguide. Moreover, the GRIN material offers additional degrees of freedom in order to optionally likewise reduce, e.g. completely or at least partially correct, the aberrations, caused by the GRIN element, in the real image of the surroundings by way of the refractive index profile and optionally by way of an adapted design of the curvature of the at least one surface, preferably of both surfaces. The at least one surface, e.g. a first and/or a second surface, can in particular be configured in spherical, cylindrical, toric or aspherical fashion or as a free-form surface.

By preference, the GRIN element consists of isotropic material without birefringence.

Advantageously, the GRIN element has a refractive index distribution additionally designed to reduce, in particular at least partially or completely correct, aberrations, induced or caused by the GRIN element, in an imaging path of a real image representation of the surroundings, i.e. the physical or actual surroundings, the said imaging path passing through the GRIN element.

In other words, the GRIN element is designed to reduce or correct the imaging errors in the input coupled virtual image which are typically created in a simple curved optical waveguide without GRIN refractive index profile, and optionally to additionally compensate the aberrations linked to the real imaging of the actual surroundings (looking through the waveguide in the direction of the surroundings). The aberrations induced by the GRIN element in the imaging path of the real image representation of the surroundings can be aberrations induced by the curvature of the GRIN element and/or induced by the refractive index distribution designed to reduce the aberrations induced in the imaging path of the virtual image representation.

The optical waveguide is advantageous in that on account of its curved embodiment it can be adapted to a meniscus shape of a lens for glasses, in particular of at least one of the lenses described at the outset. For example, significant astigmatic errors in the virtual image can be reduced or corrected by the GRIN element without impairing the view of objects in the environment through the optical waveguide. The invention enables a compact and lightweight arrangement with a reduced system thickness (see FIG. 1). This is advantageous, especially from aesthetic points of view. Significantly more appealing glasses designs can be realized in comparison with plane parallel optical waveguides. Moreover, a large aberration-free field of view (FOV) can be realized for the imaging path of the virtual image.

The concept which underlies the invention is applying the fundamentals of transformation optics (see e.g. [Pendry, Schurig, Smith, Science Vol 312, p. 1780 (2006)]) to the present situation. Transformation optics are distinguished by the capability of “bending” or steering light or electromagnetic waves in any desired way for a specific application. This is implemented by tailoring the medium in which the electromagnetic wave propagates. The required properties of the medium are derived by a mathematical transformation. The peculiarity here is that the form of Maxwell's equations is maintained even though there is a coordinate transform. Instead, there is a “transform” or change in the spatial distribution of the material parameters e (permittivity, dielectric constant) and p (magnetic permeability). The transformation properties have been described by various authors, inter alia in [A. J. Ward, J. B. Pendry, Journal of Modern Optics, 43 773-793 (1996)], [D. M. Shyroki http://arxiv.org/abs/physics/0307029v1 (2003)], [Leonhardt Ulf; Philbin, Thomas G.: Transformation Optics and the Geometry of Light, Progress in Optics, Volume 53, p. 69-152].

The essential steps of the transformation are summarized below. A coordinate transformation is performed in a first step:

$${q}_{1} ( x , y , z ) \qquad {q}_{2} ( x , y , z ) \qquad {q}_{3} ( x , y , z )$$

In a second step, Maxwell's equations are formulated in the new coordinate system, with the form of Maxwell's equations remaining unchanged.

$$∇ \times \tilde{E} = - \tilde{μ} {μ}_{0} \partial \hat{H} / \partial t$$

$$∇ \times \tilde{H} = - \tilde{ε} {ε}_{0} \partial \tilde{E} / \partial t$$

New values for ε and μ are calculated in a third step

$${\tilde{ε}}_{i} = {ε}_{i} \frac{{Q}_{1} {Q}_{2} {Q}_{3}}{{Q}_{i}^{2}}$$

$${\tilde{μ}}_{i} = {μ}_{i} \frac{{Q}_{1} {Q}_{2} {Q}_{3}}{{Q}_{i}^{2}}$$

$$where$$

$${Q}_{i}^{2} = {( \frac{\partial x}{\partial {q}_{i}} )}^{2} + {( \frac{\partial y}{\partial {q}_{i}} )}^{2} + {( \frac{\partial z}{\partial {q}_{i}} )}^{2}$$

$${\tilde{E}}_{i} = {Q}_{i} {E}_{i}$$

$${\tilde{H}}_{i} = {Q}_{i} {H}_{i} .$$

Thus, Maxwell's equations can be transformed into a new geometry or a coordinate system that is particularly advantageous for the description of a specific application. ε and μ must be modified in the process.

If a planar optical waveguide is subjected to a suitable transformation, then it can be converted into any desired shape, especially into a spherically curved optical waveguide. Conversion into e.g. a cylindrical, toric, aspherical waveguide or a waveguide designed as a free form is also possible. The refractive index profiles or the refractive index distribution (represented by way of ε and μ) should be adapted according to the transformation. The light wave field which propagates through a waveguide transformed thus remains aberration-free—like in the case of a planar optical waveguide, too. The derivation is described in detail within the scope of the first and second embodiment variant. In an advantageous variant, in particular for a cylindrically or spherically shaped optical waveguide, the refractive index and hence its profile depends on the ratio r′/r, i.e. it can be represented e.g. as a function n(r)=f(r′/r), where r′ is a specified or defined radius of curvature of one of the at least one curved surface of the GRIN element.

The refractive index distribution of the GRIN element can have a radially symmetric and/or cylindrical or cylindrically symmetric and/or toric refractive index distribution, and/or a refractive index distribution which has at least one area of constant refractive index, wherein the at least one area is configured in cylindrical or toric or spherical or aspherical fashion or as a free-form surface. The at least one area of constant refractive index can coincide with or run parallel to the at least one curved surface of the GRIN element. This variant has advantages from a manufacturing point of view. So as to impair the quality of the view of the physical surroundings through the optical waveguide as little as possible, the refractive index distribution of the GRIN element advantageously has a radially symmetric configuration (n=n(r)) in the case of a curved waveguide. The origin of the coordinate system is at the center of rotation of the eye or at a center of an eye box, or on a straight line interconnecting the center of rotation of the eye and a center of an eye box.

If R₁=r′ and R₂=r are the inner and outer radii, respectively, of a spherically curved optical waveguide, then the simple consideration of the fact that the optical path lengths along spherical faces with concentric radii R₁ and R₂ (generally with radius r) must be constant gives rise to the following relationship for the refractive index profile: n₂=n₁*R₁/R₂ or, in general in the optical waveguide, n(r)=n₁*r′/r. Let R₁=r′, and then this corresponds precisely to the profile of the extraordinary refractive index nₐₒ of a planar optical waveguide transformed into polar coordinates (see second exemplary embodiment below). Thus, in an advantageous variant, n(r)=n₁*r′/r applies to the refractive index distribution n(r) of the GRIN element in the radial direction, where r′ is the radius of curvature of the first surface, r is the radius, i.e. the distance from the origin of the coordinate system which defines the radius of curvature of the first surface r′, and n₁ is the refractive index of the GRIN element material at the first surface.

The radius of curvature of the first surface R₁=r′ and/or the radius of curvature of the second surface R₂=r can be at least 50 mm, for example between 50 mm and 1000 mm, in particular between 70 mm and 130 mm. Should the first and/or second surface be configured as a free-form surface or aspherical surface, the radius of curvature should be understood as the best fit radius. One of the surfaces can also have a planar configuration. The maximum thickness of the GRIN element can be at least 0.1 mm and/or at most 10 mm, in particular between 0.1 mm and 10 mm, preferably between 0.5 mm and 3 mm, for example between 1 mm and 2 mm, in the direction of the optical axis or the chief ray direction of an imaging path of the real image representation of the surroundings or in the radial direction. In the context of head-mounted displays, the aforementioned dimensions are particularly advantageous within the scope of an application in combination with lenses for correcting refractive errors since these dimensions enable compact optical arrangements.

In a further variant, the change in the refractive index Δn in the GRIN element is between 0.005 and 0.20. In particular, the change in the refractive index Δn in the GRIN element can be between 0.01 and 0.15, especially in the radial direction (radial refractive index difference). The gradient bn/dx of the refractive index n can for example be between 0 mm⁻¹ and 0.02 mm⁻¹ in a direction x. By preference, the gradient bn/dx of the refractive index n is between 0 mm⁻¹ and 0.02 mm⁻¹ in a direction x perpendicular to the chief ray direction of an imaging path of the real image representation of the surroundings or in a direction x parallel to the chief ray direction of an imaging path of the real image representation of the surroundings or in a radial direction x or in a direction x perpendicular to the optical axis or in a direction x parallel to the optical axis. With typical radii of lenses for glasses of the order of 100 mm and thicknesses around 1 mm, this results in a radial refractive index difference in the lens of the order of Δn˜0.01 and refractive index gradients δn/dx˜0.01 mm⁻¹. These are refractive index gradients that can easily be manufactured using current technology.

The first surface and/or second surface can be embodied in toric or spherical or aspherical or cylindrical or cylindrically symmetric fashion or as a free-form surface. Both projection imaging of the virtual image by the optical waveguide and the quality of the see-through application (real image representation of the surroundings) can thereby be optimized at the same time. Should at least one push- and/or pull-lens be used, it is included in the optimization of the see-through imaging (real image representation of the surroundings) and/or the virtual image representation. The push- and pull-lenses can be configured as separate elements attached or else connected to the optical waveguide, in particular to the GRIN element, via an air gap or via an aerogel or a liquid (embedded GRIN waveguide) and can themselves have an inhomogeneous refractive index distribution (refractive index profile) and/or free-form surfaces. The connection between push- and/or pull-lens and optical waveguide can be implemented by molding, adhesive bonding or cementing. In an alternative, the lenses can also be printed on the optical waveguide by means of 3-D printing. The lenses and the optical waveguide can also be manufactured in one piece, e.g. by means of 3-D printing.

In a further advantageous variant, the GRIN element is designed to introduce a refractive power that differs from zero, e.g. positive and/or negative refractive power, into the imaging path of the real and/or virtual image. In other words, it is designed to manipulate a beam path or a wavefront like a refractive lens or in a manner analogous to a refractive lens. Thus, the GRIN element can act like a pull-lens and/or a push-lens. Thus, it can be designed to correct refractive errors, especially sphere and/or astigmatism, and/or to focus a virtual image representation. This is advantageous in that it is possible to manage without at least one of the aforementioned lenses for correcting refractive error and/or for focusing a virtual image representation, and hence possible to reduce the system thickness. In this variant, the effect of the push-lens and/or pull-lens is taken over by the GRIN element.

A curved waveguide, in particular a waveguide matched to the meniscus shape of a lens for glasses, can be designed such that it acts like an optically flat waveguide by virtue of an appropriately designed gradient index (GRIN) material being used instead of homogeneous material. As a result of the GRIN material, appropriate design allows partial or complete compensation of the aberrations (e.g. astigmatism) arising due to the curved faces in the waveguide, and so the quality of the virtual image is acceptable to a user of a head-mounted display, e.g. an AR headset. The aberrations arising in the imaging path of a real image representation of the surroundings, i.e. in the see-through case, due to the GRIN element of the optical waveguide can be compensated for by at least one further curved GRIN element or by the push-pull-lenses. In a further embodiment, the GRIN element in the curved optical waveguide is designed such that the aberrations arising in the imaging path of a real image representation of the surroundings are small (astigmatism<0.15 dpt) and require no compensation.

In general, it might be advantageous, e.g. in the case of non-concentric radii of curvature of the surfaces, to allow an arbitrary refractive index profile n=n(x,y,z) in the GRIN element of the optical waveguide in order, in addition to the astigmatism, to minimize as many aberrations as possible, or all aberrations, of the output coupled virtual image representation that result from the deviation from an ideal, generally anisotropic refractive index profile. In principle, the refractive index within the GRIN element thus can vary in three dimensions of a defined coordinate system or reference system, i.e. have a gradient in all three dimensions. In a preferred variant, the refractive index within the GRIN element varies in at least a first and a second dimension of a defined coordinate system or reference system, i.e. has a gradient in these dimensions. The refractive index can be constant along a third dimension of the defined coordinate system, i.e. have no gradient, wherein the third dimension makes a tilt angle with the chief ray direction or the direction of the optical axis of an imaging path of the real image representation of the surroundings. By preference, the absolute value of the tilt angle is greater than 2 degrees. For example, the absolute value of the tilt angle can be between 5 degrees and 20 degrees. This configuration enables simplified production of the optical waveguide, wherein the costs therefor are reduced.

The optical arrangement can comprise at least one optical element with at least one curved surface. The at least one optical element can be embodied as a lens, e.g. a meniscus-shaped or planoconcave or planoconvex lens. For example, the lens can be embodied as a lens for glasses, in order to correct refractive errors, especially ametropia and/or presbyopia, and/or to focus a virtual image representation. The at least one optical element can also be embodied as a different optical element, for example a Fresnel lens, a diffractive or holographic optical element, or as a GRIN lens, etc. The optical arrangement can comprise at least one optical waveguide as described above.

The at least one optical element and the optical waveguide are arranged in succession in the beam path of the imaging path of the real and/or virtual image representation. The at least one optical element can be arranged upstream or downstream of the optical waveguide, in particular upstream or downstream of the GRIN element, in the beam path of the imaging path of the real and/or virtual image representation. In particular, the at least one optical element and the optical waveguide can be arranged in succession in a defined chief ray direction or direction of the optical axis of an imaging path of the real image representation of the surroundings through the at least one optical element and through the optical waveguide. Thus, the optical waveguide, in particular the GRIN element, can be arranged upstream or downstream of the at least one optical element in the beam path of the imaging path of the real and/or virtual image representation. For example, the GRIN element of the optical waveguide can be geometrically arranged between an eye box or the eye of an observer and a virtual image plane. Geometrically, the at least one optical element can be arranged between the GRIN element of the optical waveguide and an eye box or the eye of an observer.

The optical arrangement can be designed a for head-mounted display (HMD), which can be e.g. an AR headset or a VR headset, or an MR headset or a pair of AR or VR or MR glasses or an AR or VR or MR helmet or a pair of smartglasses, or for a head-up display (HUD), for a near-to-eye display or for an imaging arrangement or imaging apparatus (smartglasses with gesture recognition or eye tracking, for example).

The optical arrangement has the features and advantages already mentioned above in connection with the optical waveguide. The optical element can be configured as a refractive lens (e.g. a lens for glasses) and/or be designed to correct refractive errors, e.g. myopia and/or hyperopia and/or astigmatism and/or presbyopia etc., and/or to focus a virtual image representation. In this case, the optical element can be designed to correct refractive errors in the imaging path of the real image representation of the surroundings and/or correct refractive errors in the imaging path of the virtual image representation and/or focus the virtual image representation in the imaging path of the virtual image representation. In particular, the optical element can have a spherical or aspherical embodiment or an embodiment as a free-form lens. For example, the optical arrangement can comprise at least one push-lens and/or at least one pull-lens. The pull-lens makes a virtual image appear at a desired distance in front of the eye of the observer and optionally corrects the refractive error of the wearer for the virtual image. Depending on the refractive error, it can be converging or diverging. A push-lens ensures that the image of the physical surroundings is corrected for an observer, e.g. a spectacle wearer. Since the observer or wearer always perceives the surroundings through the system consisting of optical waveguide, push- and pull-lens, the combination of these elements must be adapted to the respective observer or wearer.

The optical waveguide is preferably configured such that the curvature of at least one of the surfaces of the GRIN element (e.g. the curvature of the first surface and/or the curvature of the second surface) is matched to the curvature of the at least one curved surface of the at least one optical element. For example, the curvature of the GRIN element can be matched to a meniscus shape of a lens for glasses. Directly placing the GRIN element against the optical element can be made possible by the curvature of the GRIN element. In particular, the GRIN element and the optical element can have the same curvature over at least 50 percent, e.g. over at least 80 percent, preferably 100 percent, of the surfaces facing one another upon contact.

The at least one optical element can be configured as a separate element or as an element connected to the optical waveguide in fixed or detachable fashion or by way of fixed spacers. The optical element in turn can have an inhomogeneous refractive index distribution and/or a free-form surface. In a further variant, the optical arrangement can comprise at least one further GRIN element for reducing, e.g. compensating, aberrations induced by the GRIN element along an imaging path of the real image representation of the surroundings. The further GRIN element can be a separate component part or element. However, it can also be a constituent part of the at least one optical element with at least one curved surface.

The image reproduction apparatus according to certain embodiments can comprise at least one optical waveguide or an optical arrangement as described above. The image capture apparatus can comprise at least one optical waveguide. The image capture apparatus can be an imaging arrangement or imaging apparatus (smartglasses with gesture recognition or eye tracking, for example). The image reproduction apparatus and the image capture apparatus may have the aforementioned features and advantages.

The invention is explained in detail below on the basis of exemplary embodiments with reference to the accompanying figures. Although the invention is more specifically illustrated and described in detail by means of the preferred exemplary embodiments, nevertheless the invention is not restricted by the examples disclosed and other variations can be derived therefrom by a person skilled in the art, without departing from the scope of protection of the invention.

The figures are not necessarily accurate in every detail and to scale and can be presented in enlarged or reduced form for the purpose of better clarity. For this reason, functional details disclosed here should not be understood to be limiting, but merely to be an illustrative basis that gives guidance to a person skilled in this technical field for using the present invention in various ways.

The expression “and/or” used here, when it is used in a series of two or more elements, means that any of the elements listed can be used alone, or any combination of two or more of the elements listed can be used. If for example a composition containing the components A, B and/or C is described, the composition may contain A alone; B alone; C alone; A and B in combination; A and C in combination; B and C in combination; or A, B, and C in combination.

### BRIEF DESCRIPTION OF THE DRAWINGS

FIG. 1 schematically shows variants of a lens arrangement of an AR headset.

FIG. 2 schematically shows the beam path through a plane parallel waveguide.

FIG. 3 schematically shows the beam path through a curved waveguide.

FIG. 4 schematically shows the transverse deviations occurring in a waveguide as shown in FIG. 3 for different viewing angles.

FIG. 5 schematically shows an optical waveguide according to certain embodiments of the invention as per a first and a second embodiment variant in cross section.

FIG. 6 shows the beam path through an optical waveguide according to certain embodiments of the invention and the refractive index distribution in the GRIN element of the optical waveguide as per a third embodiment variant.

FIG. 7 shows the transverse deviations for different angles of view for the third embodiment variant.

FIG. 8 shows the beam path through an optical waveguide according to certain embodiments of the invention and the refractive index distribution in the GRIN element of the optical waveguide as per a fourth embodiment variant.

FIG. 9 shows the transverse deviations for different angles of view for the fourth embodiment variant.

FIG. 10 shows the beam path through an optical waveguide according to certain embodiments of the invention and the refractive index distribution in the GRIN element of the optical waveguide as per a fifth embodiment variant.

FIG. 11 shows the transverse deviations for different angles of view for the fifth embodiment variant.

FIG. 12 shows the beam path through an optical waveguide according to certain embodiments of the invention and the refractive index distribution in the GRIN element of the optical waveguide as per a sixth embodiment variant.

FIG. 13 shows the transverse deviations for different angles of view for the sixth embodiment variant.

FIG. 14 shows the beam path through an optical waveguide according to certain embodiments of the invention and the refractive index distribution in the GRIN element of the optical waveguide as per a seventh embodiment variant.

FIG. 15 shows the transverse deviations for different angles of view for the seventh embodiment variant.

FIG. 16 shows the spherical refractive power of the optical waveguide of the seventh embodiment variant in an imaging path of a real image representation of the surroundings.

FIG. 17 shows the astigmatism of the optical waveguide of the seventh embodiment variant in an imaging path of a real image representation of the surroundings.

FIG. 18 shows the beam path through an optical waveguide according to certain embodiments of the invention and the refractive index distribution in the GRIN element of the optical waveguide as per an eighth embodiment variant.

FIG. 19 shows the transverse deviations for different angles of view for the eighth embodiment variant.

FIG. 20 shows the spherical refractive power of the optical waveguide of the eighth embodiment variant in an imaging path of a real image representation of the surroundings.

FIG. 21 shows the astigmatism of the optical waveguide of the eighth embodiment variant in an imaging path of a real image representation of the surroundings.

FIG. 22 schematically shows an image reproduction apparatus according to certain embodiments of the invention.

FIG. 23 schematically shows an image capture apparatus according to certain embodiments of the invention.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the scope of the invention as defined by the appended claims.

### DETAILED DESCRIPTION

In the following descriptions, the present invention will be explained with reference to various exemplary embodiments. Nevertheless, these embodiments are not intended to limit the present invention to any specific example, environment, application, or particular implementation described herein. Therefore, descriptions of these example embodiments are only provided for purpose of illustration rather than to limit the present invention.

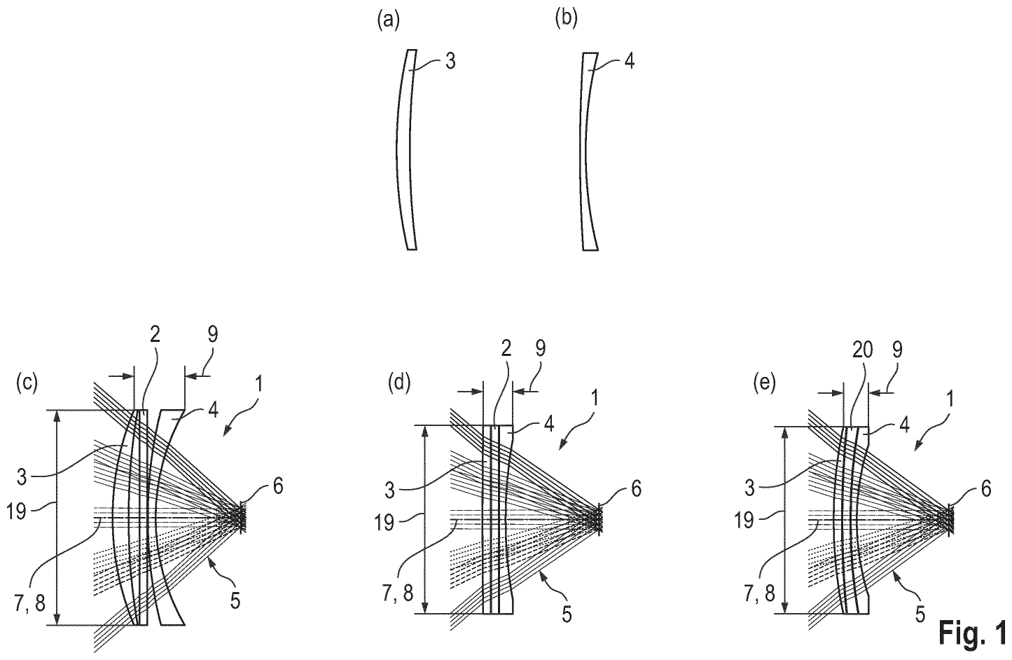

Initially, the starting point for the present invention is explained on the basis of FIGS. 1 to 4.

FIG. 1 schematically shows variants of a lens arrangement 1 of an AR headset. Here, (a) and (b) show exemplary embodiments of a positive meniscus lens 3 for glasses, which serves to correct hyperopia, and of a negative meniscus lens 4 for glasses, which serves to correct myopia, and (c) and (d) show two exemplary embodiments of a push-pull-lens combination 3, 4 including a planar optical waveguide 2 for a hyperopic headset wearer. Variant (c) fully corrects the refractive error (sphere and cylinder) in the viewing direction through the two meniscus-shaped lenses 3, 4 but has a very large system volume. By contrast, variant (d) embodies the push- and pull-lens 3, 4 as planoconvex and planoconcave lenses, respectively, which enables a substantially more compact system volume but cannot correct the refractive error sufficiently well. Embodiment variant (e) shows a curved optical waveguide 20, having a first radius R₁=r′ and a second radius R₂=r. The inner faces of the push- and pull-lenses 3, 4 have the same radius as the adjacent optical waveguide face. This form of design enables both the most compact system volume and complete correction of the refractive error. To illustrate the system volume, the system thickness is labeled by arrows with reference numeral 9 and the system volume is labeled by arrows with reference numeral 19.

The stop or eye box, i.e. the position from which a virtual image representation generated by means of the waveguide 2, 20 is visually perceivable is labeled by reference numeral 6. An optical axis 7 of the imaging path of the real image representation of the surroundings is defined starting from the eye box 6; this optical axis at the same time defines the direction of view through the lens arrangement 1. The center axis of the lens arrangement 1 is labeled by reference numeral 8 and coincides with the optical axis 7 in the examples shown.

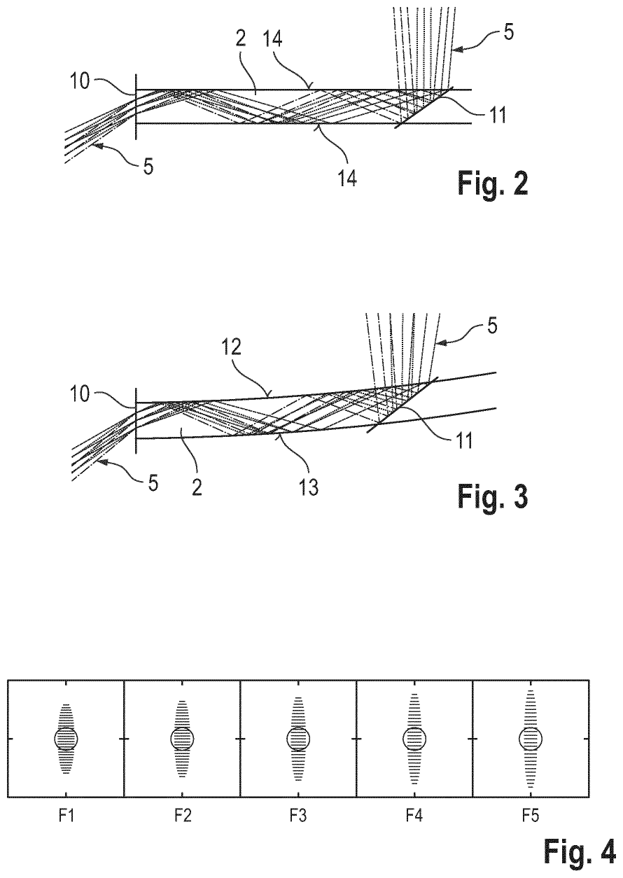

FIG. 2 schematically shows the beam path 5 through a plane parallel optical waveguide 2 which has plane faces 14. The optical waveguide 2 comprises an input coupling device 10 in the form of an input coupling face. It moreover comprises an output coupling device 11, which output couples light waves from the optical waveguide 2 in the direction of an eye box.

FIG. 3 schematically shows the beam path 5 through a curved optical waveguide 2. Collimated light is input coupled into both of the optical waveguides 2 shown in FIGS. 2 and 3, and this light is output coupled in collimated fashion in FIG. 2 after being reflected at the plane faces 14. By contrast, the output coupled light is no longer collimated in the case of the curved optical waveguide 2 in FIG. 3 and has a strong astigmatism. FIG. 4 schematically shows the transverse deviations occurring in an optical waveguide 2 as shown in FIG. 3 for different viewing angles. The reference circle shown has a diameter of 60 arcminutes.

Various embodiment variants of an optical waveguide according to the invention are explained below.

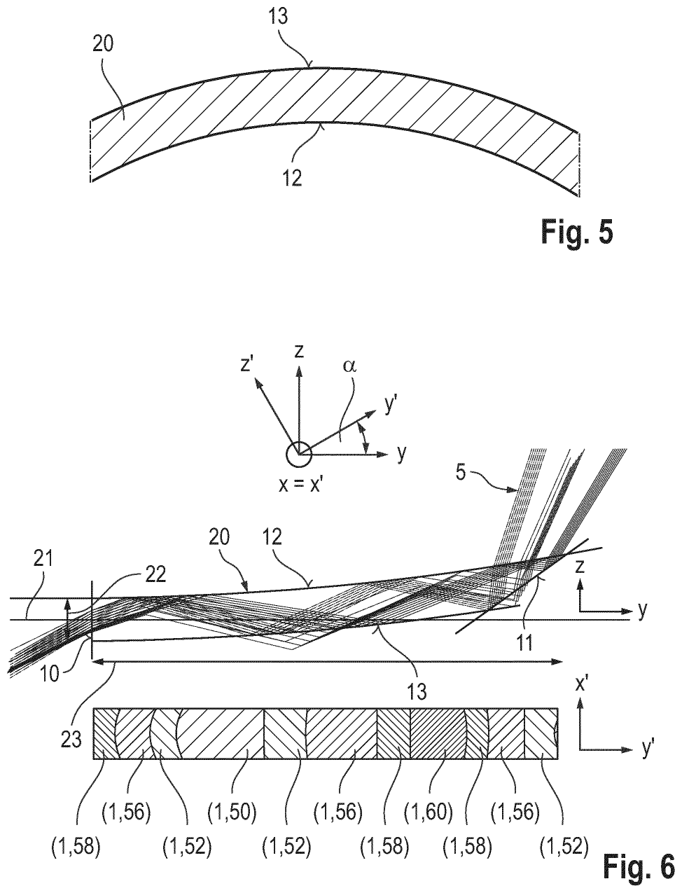

FIG. 5 schematically shows a portion or partial region of an optical waveguide 20 as per a first and a second embodiment variant in cross section. The optical waveguide 20 comprises a first surface 12 with a radius of curvature r and a second surface 13 with a radius of curvature r′. The first surface 12 and the second surface 13 are designed concentrically.

Within the scope of the first embodiment variant, the optical waveguide 20 is shaped cylindrically and the first surface 12 and second surface 13 form concentric partial cylinder barrel faces.

To transform Cartesian coordinates (x′, y′, z′) into cylindrical coordinates, the radius r′ based on Cartesian coordinates

r′=\sqrt{x′²+y′²}

is transformed into the radius r in cylindrical coordinates r=r(r′), where the angle ϕ and the coordinate z (z=z′) are maintained (see formula (5.5) in [Leonhardt Ulf; Philbin, Thomas G.: Transformation Optics and the Geometry of Light, Progress in Optics, Volume 53, p. 69-152]).

If the transformation from Cartesian to cylindrical coordinates is applied, the following arises for the dielectric tensor in Cartesian coordinates e [Leonhardt Ulf; Philbin, Thomas G.: Transformation Optics and the Geometry of Light, Progress in Optics, Volume 53, p. 69-152]:

$${ε}_{c} \frac{{r}^{′}}{rR} ( \begin{matrix}{R}^{2} {cos}^{2} ϕ + \frac{{r}^{2}}{{r}^{′2}} {sin}^{2} ϕ & ( {R}^{2} - \frac{{r}^{2}}{{r}^{′2}} ) cos ϕ + sin ϕ & 0 \\ ( {R}^{2} - \frac{{r}^{2}}{{r}^{′2}} ) cos ϕ + sin ϕ & \frac{{r}^{2}}{{r}^{′2}} {cos}^{2} ϕ + {R}^{2} {sin}^{2} ϕ & 0 \\ 0 & 0 & 1\end{matrix} )$$

The eigenvalues of the tensor are

$${∈}_{a} = R \frac{{r}^{′}}{r} , \frac{r}{{Rr}^{′}} , \frac{{r}^{′}}{rR} .$$

and hence the dielectric tensor in diagonal form is:

$$εΓ - diag ( R \frac{{r}^{′}}{r} , \frac{r}{{Rr}^{′}} , \frac{{r}^{′}}{rR} )$$

$$with$$

$$R - \frac{dr}{{dr}^{′}}$$

A corresponding derivation can also be performed for the permeability tensor μ.

Within the scope of the second embodiment variant, the optical waveguide 20 is shaped spherically and the first surface 12 and second surface 13 form concentric spherical partial faces.

In a manner analogous to the first embodiment variant, the following arises for the dielectric tensor in diagonal form for the transformation from Cartesian coordinates to polar coordinates:

$$εΓ - \frac{{r}^{′2}}{{r}^{2} {R}^{2}} diag ( {R}^{2} , \frac{{r}^{2}}{{r}^{′2}} , \frac{{r}^{2}}{{r}^{′2}} ) - diag ( R \frac{{r}^{′2}}{{r}^{2}} , \frac{1}{{R}^{2}} , \frac{1}{{R}^{2}} ) .$$

$$with$$

$$R = dr / {dr}^{′} .$$

In general, ε and μ are 2nd order tensors, and hence the transformed materials generally act like optically uniaxial or biaxial crystals. That is to say, they exhibit anisotropic properties even in the case of an isotropic initial material. If the anisotropic refractive index profile follows the specifications given by the transformation optics, then the light wave field remains aberration-free during the propagation through the waveguide. If there is no compression of the wave field along the radial direction, for example like in the case of cloaking applications, then R=dr/dr′=1. In the event of furthermore considering the transformation to polar coordinates, the dielectric tensor reduces in this case to

$$εΓ - diag ( {r}^{′2} / {r}^{2} , 1 , 1 )$$

If an initial material with dielectric constant ε and permeability μ is assumed, and if moreover μ=1 is chosen, then the plane waveguide transformed to a sphere behaves like an optically uniaxial crystal with the ordinary refractive index given by:

$${n}_{0} = \sqrt{ε}$$

and the extraordinary refractive index given by:

$${n}_{a 0} = \sqrt{ε \frac{{r}^{′2}}{{r}^{2}}} = n \sqrt{\frac{{r}^{′2}}{{r}^{2}}} = n \frac{{r}^{′}}{r}$$

It was found that |nₒ−nₐₒ|<<1 holds true for typical applications, and so anisotropic material without a birefringence can be assumed to a good approximation. In practical application, the use of isotropic materials is advantageous for manufacturing reasons.

In a manner analogous to polar coordinates, it is possible to derive the ordinary refractive index:

$${n}_{0} = \sqrt{ε} * \sqrt{\frac{{r}^{′}}{r}}$$

and the extraordinary refractive index:

$${n}_{a 0} = \sqrt{ε} * √ \frac{r}{{r}^{′}}$$

for cylindrical coordinates with R=1.

In all embodiment variants, the GRIN element can in principle be manufactured by arranging films with appropriate refractive indices on one another. In the embodiment variants, the GRIN element has a toric or spherical geometry.

A third variant is described on the basis of FIGS. 6 and 7. FIG. 6, top, defines two Cartesian coordinate systems (x,y,z) and (x′,y′,z′), which are arranged tilted to one another through an angle α about the x-axis or the x′-axis corresponding to the x-axis. In this case, the z-direction defines the chief ray direction or the direction of the optical axis of the imaging path of the real image representation of the surroundings (see-through direction). The specifications in the following figures (especially in FIGS. 6, 8 and 10) and embodiment variants likewise correspond to these coordinate systems.

FIG. 6 moreover shows the beam path through an optical waveguide 20 in cross section in a yz-plane and the refractive index distribution in the GRIN element of the optical waveguide in an x′y′-plane. The optical waveguide 20 shown has a thickness 22 of 2 mm in the z-direction and a length 23 of 22 mm in the y-direction. The optical waveguide 20 is configured in meniscus-shaped fashion, wherein the radii of curvature R₁=r′ and R₂=r of the meniscus are 125 mm. The centers of curvature are situated on the z-axis and are shifted by 2 mm with respect to one another. Thus, the outer faces of the GRIN element are not concentric in this exemplary embodiment. The considered field angle range is 10°×10°. In the example shown, the optical waveguide 20 comprises a GRIN element which consists of a GRIN material.

The refractive index distribution within the GRIN element along the x′y′-plane is shown at the bottom of FIG. 6. In this case, the refractive index preferably varies continuously, but it can also be reproduced by individual layers or regions with a constant refractive index, as shown at the bottom of FIG. 6 and in corresponding figures of the further embodiment variants. In the figures, the refractive indices of the individual regions are specified by way of example between parentheses.

The maximum refractive index difference within the GRIN element is 0.10 (Δn=0.10). The refractive index distribution is configured such that it varies in the x′y′-plane, as shown at the bottom of FIG. 6, and is constant in a 3rd dimension (along the z′-axis) which makes a tilt angle of α=−5 degrees with the z-axis at the top of the figure. The GRIN element causes light waves output coupled from the waveguide 20 to form a collimated beam path. The astigmatism in the virtual image initially caused by the curvature of the optical waveguide 20 thus is compensated by the gradient index distribution within the GRIN element.

The waveguide in FIG. 6 images an object (at infinity) in the object plane onto an image plane (at infinity). Rays emanating from a single object point form a parallel beam, i.e. all rays are parallel when they are input coupled at the input coupling face. Thus, the individual beams in FIG. 6 arise at different object points in the object plane. The angle between an incident beam and the optical axis is referred to as the field angle.

Following total-internal reflections at the outer faces of the waveguide, the beams are output coupled at different angles (angles of view) at the output coupling face. In the case of aberration-free imaging, all rays in an individual output coupled beam are once again precisely parallel to one another. However, aberrations occur, especially an astigmatism, since the refractive index distribution in the present embodiment variant does not exactly satisfy the equations of transformation optics. The individual rays in a beam then are no longer parallel but exhibit individual directional deviations (transverse deviations). The magnitudes of these transverse deviations thus are a measure for the size of the aberrations in the imaging path of the virtual image representation.

For the present embodiment variant, FIG. 7 shows the transverse deviations for different field angles in a pupil plane (x_{F}y_{F}-plane). The diameter of the reference circle shown is 2 arcminutes. XAN labels the field angle in the event of a rotation about the y_{F}-axis of the pupil plane, and YAN denotes the field angle in the event of a rotation about the x_{F}-axis of the pupil plane, in degrees in each case.

The transverse deviation shown centrally in the lower row thus relates to a field angle XAN of 0° and a field angle YAN of 0°, the transverse deviation shown to the left thereof occurs in the case of a field angle YAN of −5° and a field angle XAN of 0°. A transverse deviation for a field angle YAN of 5° and a field angle XAN of 0° are shown at the bottom-right. Since the gradient index distribution in the GRIN element is formed in mirror symmetric fashion with respect to the y′z′-plane, as shown in FIG. 6, the transverse deviations for a field angle XAN of −5° correspond to the transverse deviations for a field angle XAN of 5° shown at the top of FIG. 7. The transverse deviations are significantly reduced in comparison with FIG. 4. Thus, the refractive index distribution of the GRIN element in this embodiment variant leads to aberrations in the imaging path of the virtual image representation that arise due to the curvature of the GRIN element being reduced.

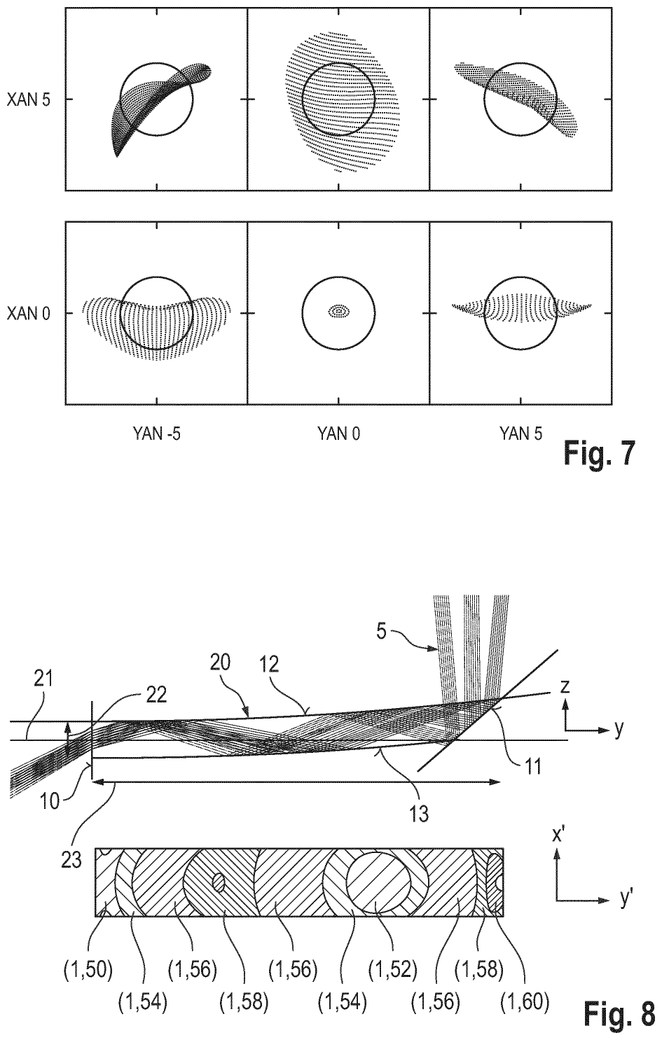

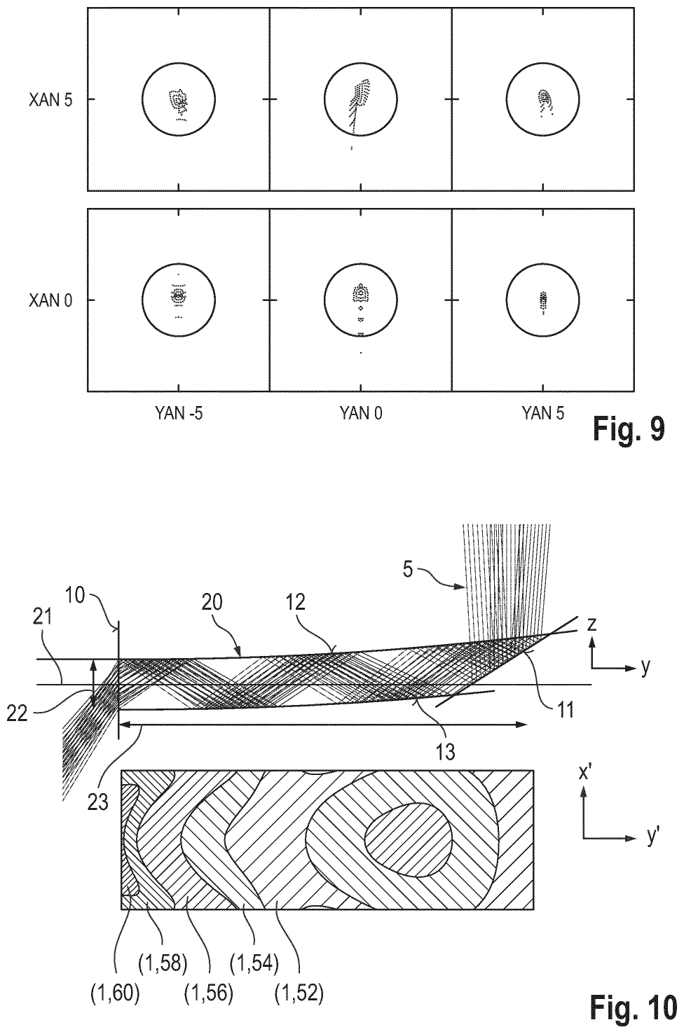

FIG. 8 shows a fourth embodiment variant. The associated transverse deviations are shown in FIG. 9. The fourth embodiment variant differs from the third embodiment variant in that the radii of curvature R₁=r′ and R₂=r of the meniscus are 200 mm, and the tilt of the GRIN medium, i.e. the tilt of the 3rd dimension (z′-axis) in which the refractive index is constant, a is =−15.6°. Thus, the 3rd dimension makes an angle of −15.6° with the z-axis or the chief ray direction or direction of the optical axis of the imaging path of the real image representation of the surroundings (see-through direction). The field angle range, the thickness 22 in the z-direction and the width 23 in the y-direction of the GRIN element correspond to those of the first embodiment variant. The calculated refractive index distribution with the smallest aberrations in the virtual image once again has a maximum difference of the refractive index Δn within the GRIN material of Δn=0.10. The refractive index distribution at the bottom of FIG. 8 has significantly stronger variations in the x-direction when compared with the third embodiment variant. However, the stronger tilt in the 3rd dimension causes a significant reduction in the transverse aberrations, as is evident in FIG. 9. Thus, the refractive index distribution of the GRIN element in this embodiment variant leads to aberrations in the imaging path of the virtual image representation that arise due to the curvature of the GRIN element being reduced even more.

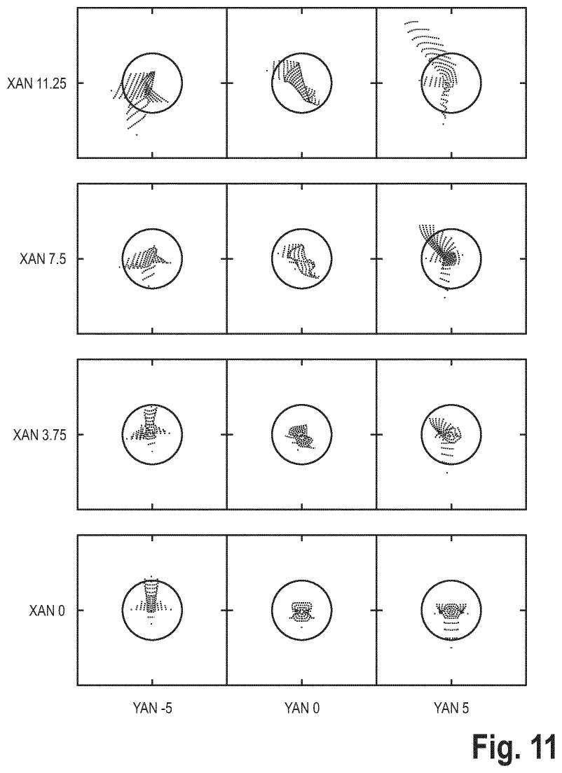

A fifth embodiment variant is explained below on the basis of FIGS. 10 and 11. In the third embodiment variant, the optical waveguide 20 has radii of curvature R₁=R₂ of the meniscus of 90 mm in the region of the GRIN element. The considered field angle range is 22.5°×10°. The GRIN element has a thickness 22 of 1.2 mm and a width 23 of 10 mm. The maximum refractive index difference in the GRIN material is 0.12 (Δn=0.12). The 3rd dimension (z′-axis) in which the refractive index is constant makes an angle of α=14° with the z-axis in the event of a rotation about the x-axis. The refractive index distribution in the x′y′-plane is shown at the bottom of FIG. 10. FIG. 11 shows the transverse deviations, arising in this embodiment variant, for field angles YAN of −5° to 5° and for field angles XAN of 0° to 11.25°. The diameter of the reference circle shown is 2 arcminutes. In comparison with the previous embodiment variants, the transverse deviations of this embodiment variant are sufficiently small even in the event of field angles XAN of greater than 5°.

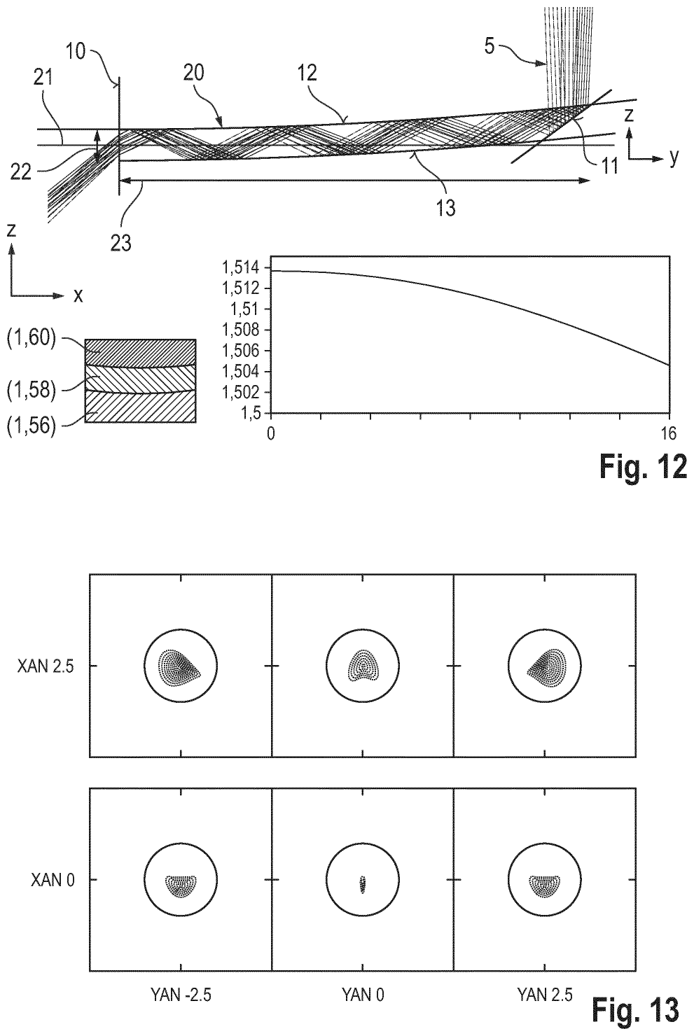

A sixth embodiment variant is explained in detail below on the basis of FIGS. 12 and 13. In this embodiment variant, the radii of curvature of the meniscus of the GRIN element are 150 mm. The field angle range is 5°×5°. The GRIN element shown has a thickness of 1.0 mm and a width of 15 mm.

FIG. 12, bottom left, shows the refractive index distribution in the form of a cross section in an xz-plane. Here, the refractive index in the y-direction is constant. This means that the refractive index profile does not align with the outer faces, i.e. the first surface and the second surface. The diagram bottom right of FIG. 12 shows the refractive index profile on the second surface, i.e. the front side of 13 of the optical waveguide 20 shown in FIG. 12, at x=0, i.e. in the plane of the drawing. The position along the surface is plotted on the x-axis of the diagram. The respective refractive indices are plotted on the y-axis of the diagram. The refractive index reduces as the y-value increases, i.e. reduces along the surface 13 starting from the input coupling face 10.

The transverse deviations for the sixth embodiment variant are shown schematically in FIG. 13. Like in the above-described embodiment variants, the diameter of the reference circle shown is 2 arcminutes.

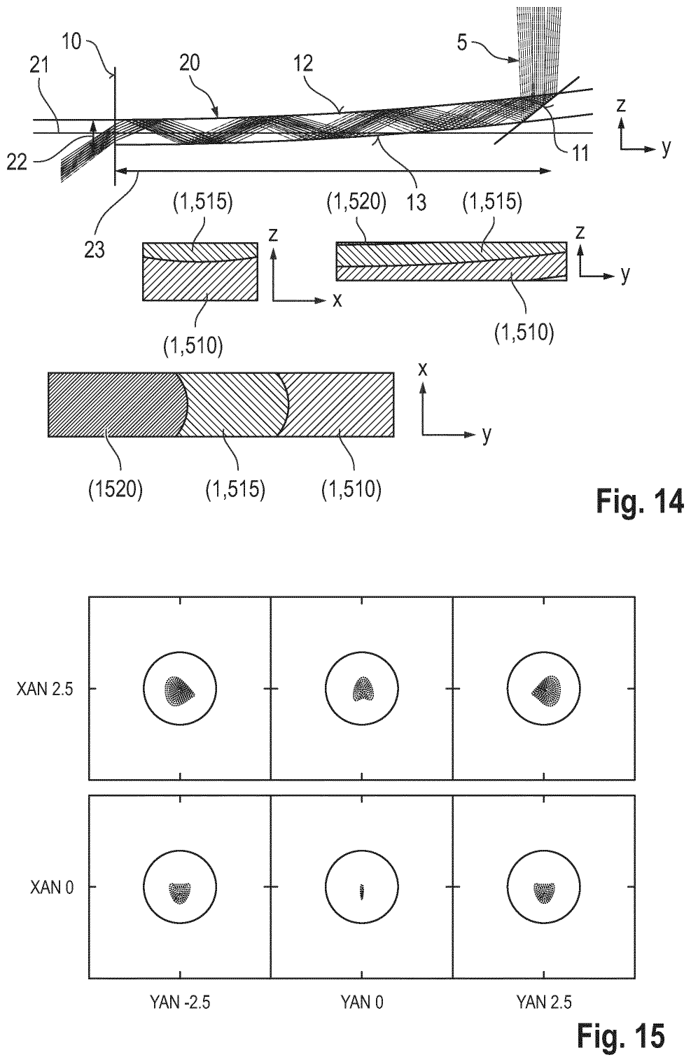

A seventh embodiment variant is explained below on the basis of FIGS. 14 to 17. In this variant, the astigmatism in the virtual image is corrected for the field angle of 5×5°. In the region of the GRIN element, the waveguide 20 has a thickness of 1 mm and a length of 18 mm. In this embodiment variant, the radius of curvature of the concave face 12 of the meniscus of the GRIN element of the optical waveguide 20 is 150 mm. The second surface, i.e. the convex face 13 of the meniscus, is designed as a torus. The radius of curvature of the second surface 13 in the image plane Rz (radius in the event of a rotation about the x-axis) is 150.0 mm. The radius of curvature perpendicular to the image plane Rx (radius in the event of a rotation about the y-axis) is 134.5 mm.

In this embodiment variant, the astigmatism is corrected not only for the virtual image but also for the imaging path of the image representation of the physical surroundings (as seen through the waveguide). In this case, the toric design of the second surface is necessary in order to compensate for the astigmatism that arises in the see-through direction as a result of designing the waveguide as a GRIN element.

The maximum refractive index difference in the GRIN material is 0.02 (Δn=0.02), where the refractive index assumes values from 1.50 to 1.52. In the present example, the refractive index distribution aligns with the convex outer face, i.e. the second surface 13. That is to say the refractive index is constant on the convex outer face, but the refractive index increases in the interior of the optical waveguide with increasing distance from the convex outer face. From a manufacturing point of view, this is advantageous in that films with corresponding refractive indices can be arranged on one another. FIG. 14, bottom, shows the refractive index distributions for various sectional planes. In this case, the diagram shown center left shows the distribution in a section in an xz-plane, the drawing shown center right shows a section in a yz-plane, and the drawing shown at the bottom shows a section in an xy-plane. FIG. 15 shows the transverse deviations for this embodiment variant.

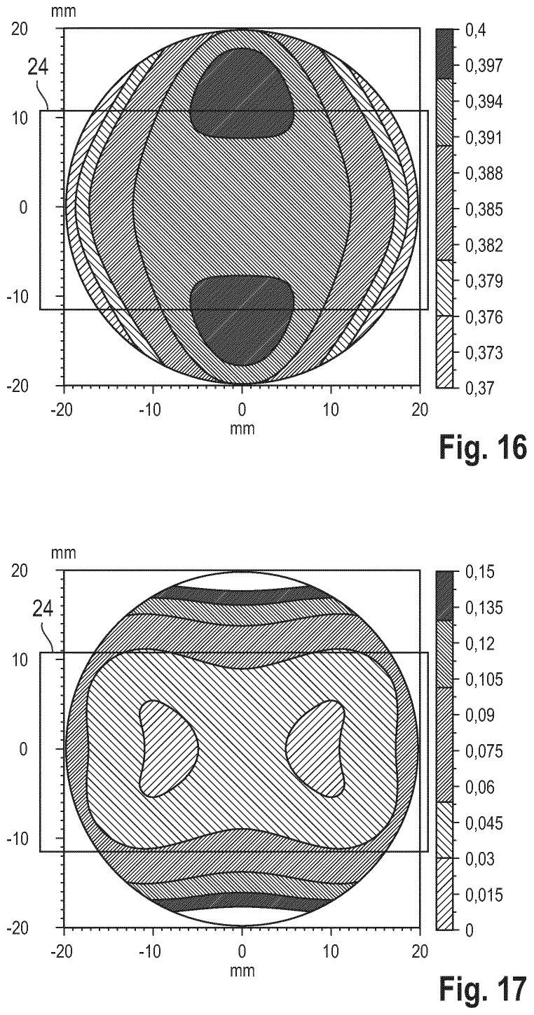

FIG. 16 shows the spherical refractive power in an imaging path of a real image representation of the surroundings (see-through direction) in diopters for the optical waveguide 20 of the seventh embodiment variant in an xy-representation. The scale on the right labels the refractive power in diopters. Dimensions in mm are plotted on the x-axis and the y-axis. In this case, the refractive power has a value of 0.385 diopter+/−0.015 diopter. Thus, the optical waveguide influences the spherical refractive power by a constant absolute value, which can be made available by the push-pull concept. The see-through astigmatism in diopter is depicted in the form of a diagram in FIG. 17. The scale on the right labels the astigmatism in diopters. The see-through astigmatism through the optical waveguide 20 of the seventh embodiment variant is less than 0.05 diopters (dpt) in the marked region 24. Thus, no compensation is required.

In FIGS. 16 and 17, the marked region 24 has a size of approx. 40 mm×20 mm. The refractive index distribution and the convex outer face of the optical waveguide are matched to one another such that when seen through the optical waveguide the astigmatism is less than 0.05 dpt and hence the objects in the environment are image virtually without aberrations The spherical refractive power of the optical waveguide is virtually constant in the entire region and can thus be made available, i.e. exploited, e.g. in the event of a push-pull concept

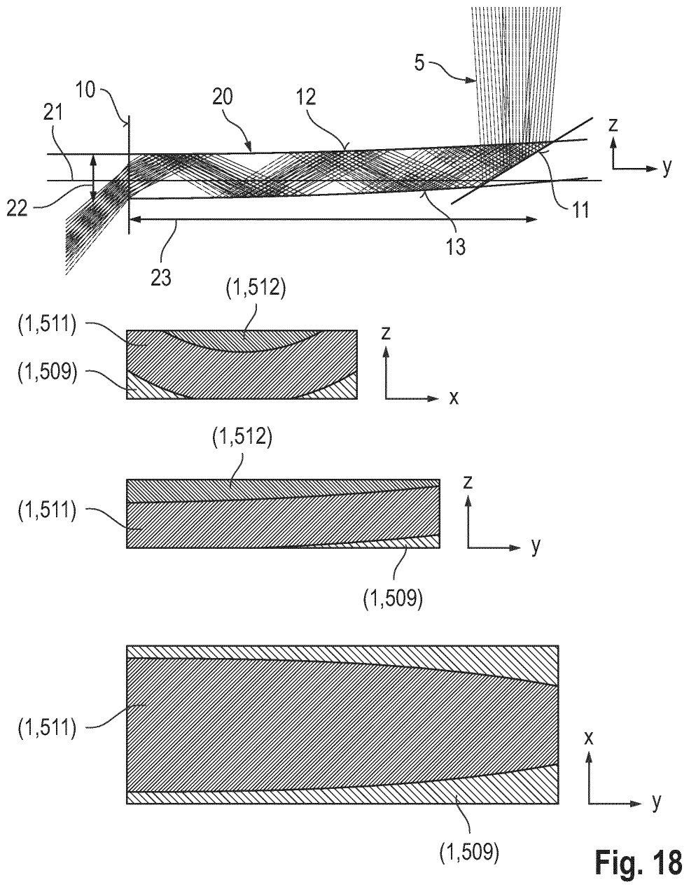

An eighth embodiment variant is explained below on the basis of FIGS. 18 to 21. In this variant, the first surface and the second surface each have a meniscus shape with different radii of curvature. The first surface, i.e. the concave face facing the eyes, has a spherical design with a radius of curvature of 200 mm. The second surface, i.e. the convex surface of the meniscus, has the design of a torus with a radius of curvature Rz of 140 mm and a radius of curvature Rx of 133.6 mm. In this variant, the field angle range is 40°×10°. The maximum refractive index difference in the GRIN material is 0.01 (Δn=0.01), where the refractive index assumes values from 1.51 to 1.52. The refractive index distribution aligns with at least one of the outer faces, i.e. with the first surface and/or the second surface. The GRIN element has a thickness 22 of 1.2 mm and a width 23 of 12 mm. In FIG. 18, the refractive index distributions are shown in a section in an xz-plane, in a section in a yz-plane and in a section in an xy-plane. The shown region has an extent of 10 mm in the x-direction.

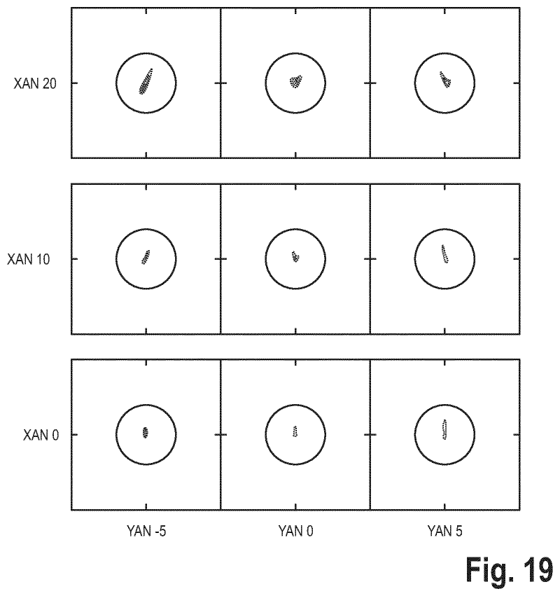

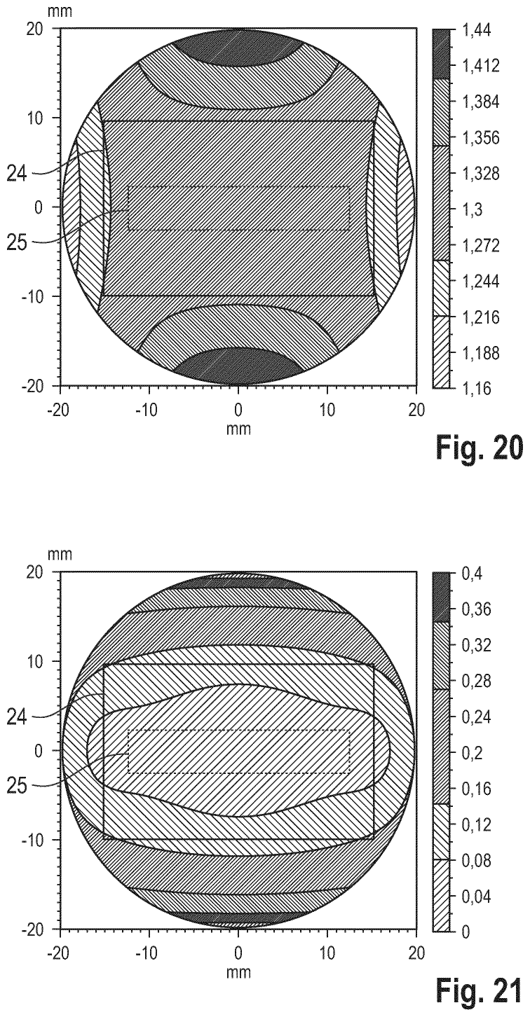

For this variant, FIG. 19 shows the transverse deviations for different viewing angles. The diameter of the reference circle is 2 arcminutes. FIG. 20 shows the spherical refractive power in diopters, and FIG. 21 shows the see-through astigmatism in diopters through the optical waveguide. In the two figures, the dashed region 25 in each case marks the extent of the optical waveguide in the x-direction and y-direction in the event of a field of view of 40°×10°. In FIG. 19, the spherical refractive power of the optical waveguide is 1.3 diopters+/−0.04 diopters, which can be used in the event of an integration in a push-pull-lens. Even without a push/pull-lens, the refractive power of the optical waveguide can be used to correct a refractive error, in particular up to 1.3 diopters. It is evident from FIG. 20 that the see-through astigmatism through the optical waveguide is less than 0.05 diopters, i.e. requires no further compensation.

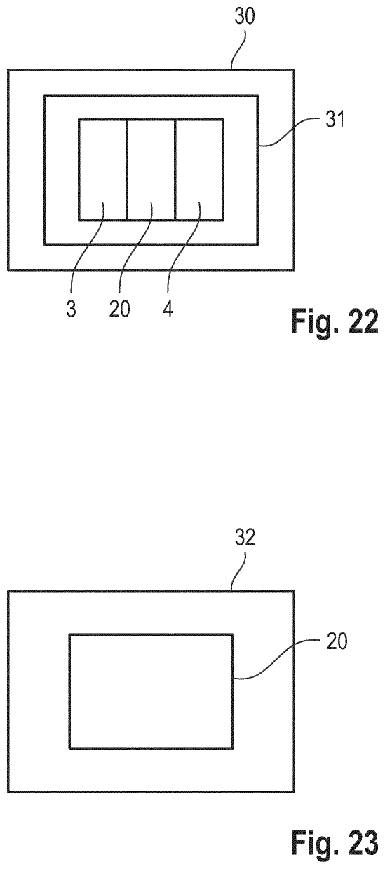

FIG. 22 schematically shows an image reproduction apparatus 30, e.g. a head-mounted display, which comprises an optical arrangement 31. The optical arrangement 31 comprises an optical waveguide 20, in particular an optical waveguide according to one of the above-described embodiment variants. The optical arrangement 31 moreover comprises at least one optical element 3, 4, for example a lens. The optical element 3, 4 can be configured as a push-lens and/or pull-lens. The optical element 3, 4 can be designed to correct refractive errors and/or to focus a virtual image representation, etc. In an alternative to the variant shown in FIG. 22, an image reproduction apparatus 30 might only comprise an optical waveguide 20 rather than the optical arrangement 31.

FIG. 23 schematically shows an image capture apparatus 32, which comprises at least one optical waveguide 20 according to the invention. In this case, the output coupling device 11 is designed as input coupling device, and the input coupling device or input coupling face 10 is designed as output coupling price or output coupling face.

### LIST OF REFERENCE SIGNS

1 Lens arrangement
2 Waveguide
3 First lens
4 Second lens
5 Beam path
6 Eye box
7 Optical axis
8 Central axis
9 System thickness
10 Input coupling device/input coupling face
11 Output coupling device
12 Concavely curved, first surface
13 Convexly curved, second surface
14 Plane surface
19 System diameter
20 Optical waveguide
21 xy-plane
22 Thickness
23 Length
24 Marked region
25 Marked region
30 Image reproduction apparatus
31 Optical arrangement
32 Image capture apparatus
XAN Field angle
YAN Field angle
x Coordinate
y Coordinate
z Coordinate
x′ Coordinate
y′ Coordinate
z′ Coordinate

1-23. (canceled)

24. An optical waveguide for arrangement in the beam path of an optical arrangement having a device for output coupling and/or input coupling an imaging beam path, the optical waveguide comprising:
a GRIN element having at least one curved surface,
wherein the GRIN element has a refractive index distribution that reduces aberrations, brought about by a curvature of the GRIN element, in an imaging path of a virtual image representation created by light waves guided in the optical waveguide by total-internal reflection.

25. The optical waveguide of claim 24, wherein the GRIN element has a refractive index distribution that reduces the aberrations, induced by the GRIN element, in an imaging path extending through the GRIN element, the imaging path being that of a real image representation of a surroundings.

26. The optical waveguide of claim 25, wherein the aberrations induced by the GRIN element in the imaging path of the real image representation of the surroundings are aberrations induced by the curvature of the GRIN element and/or induced by the refractive index distribution to reduce the aberrations induced in the imaging path of the virtual image representation.

27. The optical waveguide of claim 24, wherein the refractive index distribution of the GRIN element has a radially symmetric and/or cylindrical and/or toric refractive index distribution, and/or a refractive index distribution which has at least one area of constant refractive index.

28. The optical waveguide of claim 27, wherein the at least one area of constant refractive index is configured in cylindrical and/or toric and/or spherical and/or aspherical fashion or as a free-form surface.

29. The optical waveguide of claim 27, wherein the at least one area of constant refractive index coincides with or runs parallel to the at least one curved surface of the GRIN element.

30. The optical waveguide of claim 24, wherein n(r)=f(r′/r) applies to the refractive index distribution of the GRIN element in the radial direction, where r′ is a specified radius of curvature of one of the at least one curved surfaces of the GRIN element.

31. The optical waveguide of claim 24, wherein a radius of curvature R₁=r′ of a first surface of the GRIN element and/or the radius of curvature R₂=r of a second surface of the GRIN element is at least 50 mm, and/or a thickness of the GRIN element in the chief ray direction of an imaging path of the real image representation of the surroundings or in the radial direction is at least 0.1 mm and/or at most 10 mm.

32. The optical waveguide of claim 24, wherein a change in the refractive index Δn in the GRIN element is between 0.005 and 0.20.

33. The optical waveguide of claim 24, wherein a change in the refractive index Δn in the GRIN element is between 0.01 and 0.15 in the radial direction.

34. The optical waveguide of claim 24, wherein a gradient Sn/dx of the refractive index n is between 0 mm⁻¹ and 0.02 mm⁻¹ in a direction x.

35. The optical waveguide of claim 34, wherein the gradient Sn/dx of the refractive index n is between 0 mm⁻¹ and 0.02 mm⁻¹ in a direction x perpendicular to the chief ray direction of an imaging path of the real image representation of the surroundings or in a direction x parallel to the chief ray direction of an imaging path of the real image representation of the surroundings or in a radial direction x or in a direction x perpendicular to the optical axis or in a direction x parallel to the optical axis.

36. The optical waveguide of claim 24, wherein the first surface and/or second surface are/is embodied in toric or spherical or aspherical or cylindrical fashion or as a free-form surface.

37. The optical waveguide of claim 24, wherein the refractive index within the GRIN element varies in at least a first and a second dimension of a defined coordinate system.

38. The optical waveguide of claim 37, wherein the refractive index is constant along a third dimension of the defined coordinate system, and wherein the third dimension makes a tilt angle with the chief ray direction of an imaging path of the real image representation of the surroundings.

39. The optical waveguide of claim 38, wherein an absolute value of the tilt angle is greater than 2 degrees.

40. The optical waveguide of claim 24, wherein the GRIN element is configured to introduce a refractive power that differs from zero into the imaging path of the real and/or virtual image.

41. An optical arrangement, comprising:
at least one optical element having at least one curved surface; and
at least one optical waveguide according to claim 24,
wherein the at least one optical element and the at least one optical waveguide are arranged in succession in a beam path of an imaging path of the real and/or virtual image representation.

42. The optical arrangement of claim 41, wherein the optical element is configured as a lens and/or designed to correct refractive errors in the imaging path of the real image representation of the surroundings and/or correct refractive errors in the imaging path of the virtual image representation and/or focus the virtual image representation in the imaging path of the virtual image representation.

43. The optical arrangement of claim 41, wherein the optical waveguide is designed such that the curvature of at least one of the surfaces of the GRIN element is matched to the curvature of the at least one curved surface of the at least one optical element.

44. The optical arrangement of claim 41, wherein at least one further GRIN element is present in order to reduce aberrations induced by the GRIN element along an imaging path of a real image representation of a surroundings.

45. An image capture apparatus, comprising:
at least one optical waveguide according to claim 24.

46. An image reproduction apparatus, comprising:
at least one optical waveguide according to claim 24, or
the optical arrangement according to claim 41.
